(19) United States
(12) Patent Application Publication
(10) Pub. No.: US 2010/0043388 A1
(43) Pub. Date: Feb. 25, 2010

(54) Gas turbine engine arrangement

(75) Inventors: Samuel A. Mason, Derby (GB); Rory D. Stieger, Derby (GB)

Correspondence Address: OLIFF & BERRIDGE, PLC, P.O. BOX 320850, ALEXANDRIA, VA, 22320-4850, US

(73) Assignee: ROLLS-ROYCE PLC, London (GB)

(21) Appl. No.: 12/457,159

(22) Filed: Jun. 2, 2009

(30) Foreign Application Priority Data
Jul. 28, 2008 (GB) 0813673.1

(51) Int. Cl. F02C 7/00

(52) U.S. Cl. 60/39.511

(57) ABSTRACT

A gas turbine engine (10) comprising a compressor (14), a turbine (16) a combustor (20) and a recuperator (26), a first portion air (22) from the compressor (20) is ducted into the combustor (20) where it mixes with fuel and is burned, a second portion (24) of compressor air passes through a high-pressure side of the recuperator (26) where it is heated by gas (32) ducted from the turbine (16), the second portion of air (24) flowing through the recuperator (26) is mixed with the first portion of gas (22) to form a third gas flow (30) which is ducted into the turbine (16).

The present invention relates to a gas turbine engine comprising a recuperator and a pressure-gain combustor for an improved efficiency cycle.

A pressure-gain combustor is a combustion device that expels combustion products at a higher stagnation pressure than the incoming air. This is in contrast to conventional gas turbine combustion chambers in which a pressure drop is experienced. The increased stagnation pressure at the combustor exit means that pressure-gain combustor gas turbine cycles operate with a higher thermal efficiency than gas turbines utilising conventional combustion chambers. There are several types of pressure-gain combustor but a common feature is that they all contain regions of unsteady gas flow. Two types of well-known pressure-gain combustor are a pulse detonation combustor (e.g. US2008/0115480 A1) and a pulse pressure-gain combustor. Pulse pressure-gain combustors can be further subdivided into the valveless type (e.g. U.S. Pat. No. 4,033,120) and the valved type (e.g. a pulse jet commercially available from Dynajet).

A recuperator is a heat exchanger in a gas turbine cycle which permits the transfer of heat from the engine exhaust to the pre-combusted air. The recuperator recovers heat from the exhaust efflux and injects it back into the cycle. Recuperation therefore decreases the quantity of fuel needed to achieve a given turbine entry temperature, thereby increasing the thermal efficiency of the gas turbine. A further benefit of a recuperator is that it reduces the engine exhaust temperature, thereby improving the infra-red signature of the host aircraft.

Pressure-gain combustors and recuperators both favour low pressure ratio cycles. In the case of a pressure-gain combustor, this is because low pressure ratio cycles have a large temperature ratio across the combustor, and it is this temperature ratio that drives the pressure-gain. In the case of a recuperator, this is because low pressure ratio cycles generally have a high temperature difference between the exhaust efflux and the compressor delivery gas flow, making it easier to transfer heat therebetween.

On first inspection, it would appear beneficial to combine a recuperator in series with a pressure-gain combustor on a low pressure ratio cycle and thereby gain the thermal efficiency benefits offered by both technologies. This is not the case, however, because the recuperator decreases the temperature ratio across the combustor, thereby decreasing the pressure-gain that it is able to generate. That is to say, the recuperator disadvantages the performance of the pressure-gain combustor.

A further disadvantage of recuperators is that they always introduce a pressure loss due to gas flow friction. The overall recuperated cycle performance is very sensitive to the magnitude of this pressure loss. In order to minimise this pressure loss it is necessary to reduce the flow velocity through the recuperator, which invariably results in a bulky and heavy heat exchanger.

Therefore it is an object of the present invention to provide a gas turbine cycle which solves the aforementioned problems, improves efficiency and reduces exhaust temperature.

In accordance with the present invention there is provided a gas turbine engine comprising a compressor, a turbine, a combustor and a recuperator, a first portion of air from the compressor is ducted into the combustor where it mixes with fuel and is burned, a second portion of compressor air passes through a high-pressure side of the recuperator where it is heated by gas ducted from the turbine, the second portion of air flowing through the recuperator is mixed with the first portion of air to form an third gas flow which is ducted into the turbine.

Preferably, the gas ducted from the turbine, that passes through the recuperator and is cooled is ducted to an exhaust nozzle for discharge.

Preferably, gas flow through the combustor leaves the combustor at a higher pressure than that leaving the compressor.

Preferably, the combustor is any one of the group comprising a pulse pressure-gain combustor, a pulsejet combustor, a pulse detonation combustor and a wave rotor combustor.

Alternatively, the second portion of air passes through a compression device to boost the pressure before entering the recuperator. Preferably, the compression device is a stage of an axial or centrifugal compressor.

Advantageously, an ejector is provided downstream of the combustor and recuperator to transfer energy from the combustor gas flow to the recuperator gas flow thereby pumping gas through the recuperator.

Alternatively, an ejector is provided upstream of the recuperator and is supplied by a backflow from the combustor to transfer energy from the backflow to the recuperator gas flow thereby pumping gas through the recuperator.

Alternatively, an ejector is provided downstream of the recuperator and is supplied by a backflow from the combustor to transfer energy from the backflow to the recuperator gas flow thereby pumping gas through the recuperator.

Optionally, the gas turbine engine comprises at least one shaft.

The present invention will be more fully described by way of example with reference to the accompanying figures.

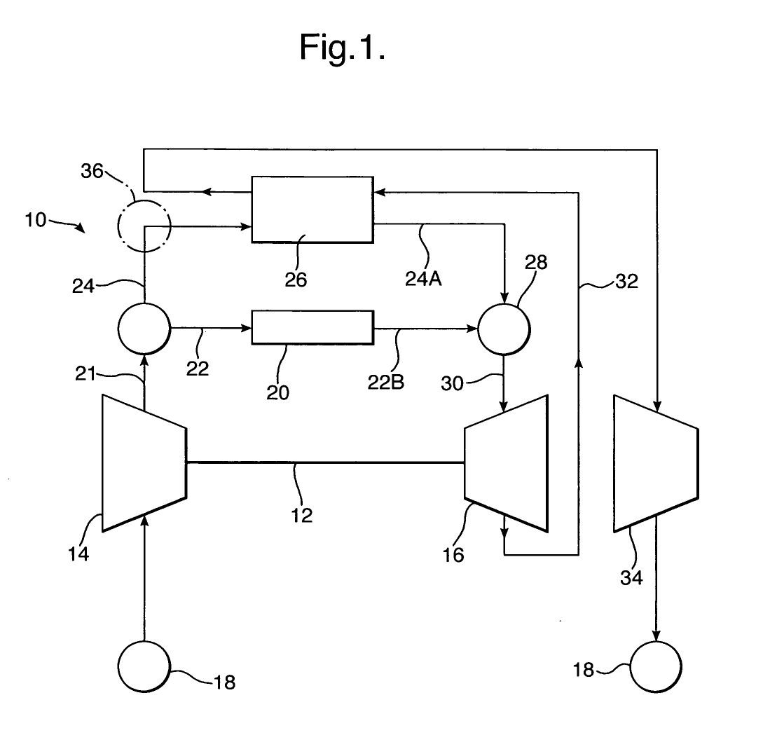

FIG. 1 is a schematic section of part of a gas turbine engine incorporating a recuperator and a pressure-gain combustor in accordance with the present invention;

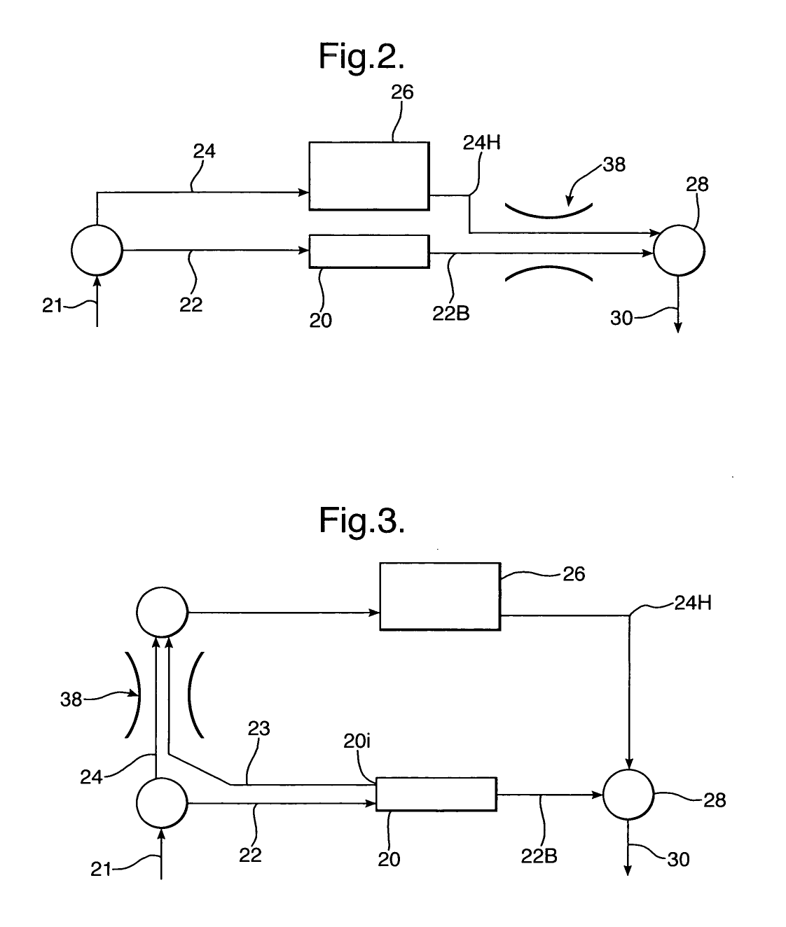

FIGS. 2, 3 and 4 show alternative embodiments of the gas turbine each comprising an ejector.

FIG. 1 shows just one shaft 12 connecting between a compressor 14 and a turbine 16 of a gas turbine engine 10 and incorporating the present invention. The gas turbine engine may have one or two additional shafts and is otherwise generally conventional in configuration and operation.

The compressor 14 draws air from the atmosphere 18 and delivers it at an elevated pressure and temperature. A first portion of air 22 from the compressor 14 then enters a pressure-gain combustor 20 where it mixes with fuel and is burned. The stagnation pressure of the flow 22B leaving the combustor 20 is at a higher pressure than that leaving the compressor 14. A second portion 24 of compressor air passes through a high-pressure side of a heat exchanger 26 (recuperator) where it is heated. Typically the quantity of the second portion of air 24 flowing through the recuperator will be at least as much as the first portion 22. The heated air 24H is then mixed at 28 with the combustion gases 22B. This gas mixture 30 then enters the turbine 16, which provides power to drive the compressor 14. A gas flow 32 from turbine 16 is fed through a low-pressure side of the recuperator 26 where it relinquishes some of its thermal energy to the second air flow 24, 24H. Finally, this cooled gas flow 32 is passed through a propelling nozzle 34 which exhausts to the atmosphere 18.

This thermodynamic cycle offers a higher thermal efficiency than both the simple recuperated cycle and the simple pressure-gain combustion cycle. Furthermore, this thermodynamic cycle offers a higher thermal efficiency than combining a pressure-gain combustor and a recuperator in series.

The combustor bypass air 24 may contain a significant level of unsteadiness by virtue of the unsteady combustion processes. Advantageously, the effect of this unsteady flow is to increase the convective heat transfer coefficient on the air-side 24 of the recuperator 26. This permits a more compact heat exchanger design requiring less surface area than would be possible with a substantially steady flow.

The pressure-gain combustor 20 may be any one of the following a pulse pressure-gain combustor (or pulsejet), a pulse detonation combustor, a wave rotor combustor, or any other pressure-gain combustor that benefits from operating over a high temperature ratio.

The recuperator 26 may be any form of two-fluid heat exchanger suitable for operating at elevated pressures and temperatures.

The combustor bypass flow 24 may be boosted in pressure before entering the recuperator 26. This may be achieved using a conventional compression device 36 such as one or more stages of axial or centrifugal compressor.

Alternatively, and referring to FIGS. 2 and 3, an ejector 38 may be used to help pump compressor delivery air 21 through the recuperator 26. The ejector 38 is a well known device containing no moving parts and transfers kinetic energy from a high pressure fluid to a low pressure fluid by mixing the two fluids together.

The arrangement of FIG. 2, comprises the ejector 38 positioned downstream of the combustor 20 and recuperator 26 such that both the fluid flows 22B and 24H pass through the ejector 38. Kinetic energy from the high pressure fluid 22B from the combustor is transferred to the low pressure fluid 24H exiting the recuperator 26 thereby increasing the flow through the recuperator 26.

The arrangement of FIG. 3, comprises the ejector 38 positioned upstream of the combustor 20 and recuperator 26 such that the fluid flow 24 passes through the ejector 38. Advantageously, a valve-less pulse pressure-gain combustor 20 may be configured to also produce an oscillating, high velocity backflow 23 from an inlet 20i of the combustion chamber 20. This backflow 23 generally comprises compressor delivery gas and does not contain any combustion products. The backflow gas 23 is supplied to the ejector 38, which is arranged to utilise the kinetic energy of this backflow 23 to entrain and pump compressor delivery fluid 24 through the high-pressure side of the recuperator 26.

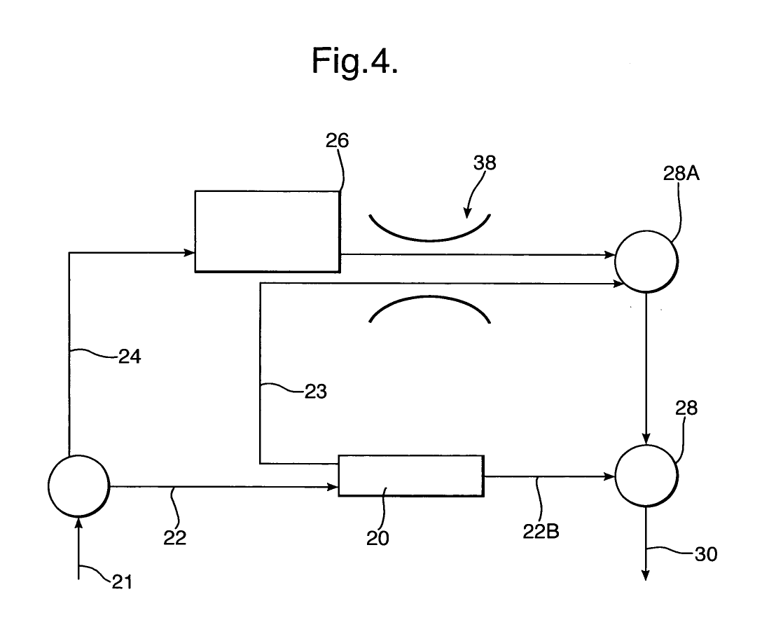

In another alternative embodiment in FIG. 4, the arrangement again utilises the kinetic energy in the backflow 23 from a valve-less pulse pressure-gain combustor 20, but features the ejector 38 positioned downstream of the recuperator 26. Similarly to the FIG. 3 embodiment, the arrangement entrains and pumps compressor delivery fluid 24 through the high-pressure side of the recuperator 26.

As well as the valve-less pulse pressure-gain combustor, a valved pulse pressure-gain combustors and a pulse detonation combustor which all produce an oscillating, high-velocity flow of combustion products 22B from their downstream end may also be utilised.

In its simplest form this invention could be applied to a single shaft turbojet. However, it could also be applied to small turboshafts (e.g. for helicopter engines) and to two- and three-shaft turbofans. It could also be used for gas turbines designed to produce energy both on land and at sea.

We claim:

1. A gas turbine engine comprising a compressor, a turbine a combustor and a recuperator, a first portion of air from the compressor is ducted into the combustor where it mixes with fuel and is burned, a second portion of compressor air passes through a high-pressure side of the recuperator where it is heated by gas ducted from the turbine, the second portion of air flowing through the recuperator is mixed with the first portion of air to form an third gas flow which is ducted into the turbine.

2. A gas turbine engine as claimed in claim 1 wherein the gas ducted from the turbine, that passes through the recuperator and is cooled is ducted to an exhaust nozzle for discharge.

3. A gas turbine engine as claimed in claim 1 wherein gas flow through the combustor leaves the combustor at a higher pressure than that leaving the compressor.

4. A gas turbine engine as claimed in claim 1 wherein the combustor is any one of the group comprising a pulse pressure-gain combustor, a pulsejet combustor, a pulse detonation combustor and a wave rotor combustor.

5. A gas turbine engine as claimed in claim 1 wherein the second portion of air passes through a compression device to boost the pressure before entering the recuperator.

6. A gas turbine engine as claimed in claim 5 wherein the compression device is a stage of an axial or centrifugal compressor.

7. A gas turbine engine as claimed in claim 1 wherein an ejector is provided downstream of the combustor and recuperator to transfer energy from the combustor gas flow to the recuperator gas flow thereby pumping gas through the recuperator.

8. A gas turbine engine as claimed in claim 1 wherein an ejector is provided upstream of the recuperator and is supplied by a backflow from the combustor to transfer energy from the backflow to the recuperator gas flow thereby pumping gas through the recuperator.

9. A gas turbine engine as claimed in claim 1 wherein an ejector is provided downstream of the recuperator and is supplied by a backflow from the combustor to transfer energy from the backflow to the recuperator gas flow thereby pumping gas through the recuperator.

10. A gas turbine engine as claimed in claim 1 wherein the gas turbine engine comprises at least one shaft.
